(19) United States
(12) Patent Application Publication
(10) Pub. No.: US 2013/0309433 A1
(43) Pub. Date: Nov. 21, 2013

(54) SCREEN PROTECTIVE FILM STRUCTURE

(71) Applicant: FU-YI HSU, TAITUNG COUNTY (TW)

(72) Inventor: FU-YI HSU, TAITUNG COUNTY (TW)

(21) Appl. No.: 13/473,669

(22) Filed: May 17, 2012

(51) Int. Cl. B32B 3/06

(52) U.S. Cl. 428/38

(57) ABSTRACT

The instant disclosure relates to a screen protective film structure for disposing on an outer surface of an electronic device. The electronic device has a display portion and a frame portion. The screen protective film structure has a light-permitting film and an adhesive portion. The light-permitting film is disposed on one side of the display portion. A central space is formed between the light-permitting film and the display portion. The adhesive portion is connected to the light-permitting film and having a plurality of adhesive protrusions. The adhesive protrusions are abutted to the frame portion, and a gap is formed between the adhesive protrusions. The gap is in communication with the central space and the ambient. Thus, trapped air between the screen protective film structure and the electronic device can be relieved.

### BACKGROUND OF THE INVENTION

1. Field of the Invention

The instant disclosure relates to a screen protective film structure; more particular, to a multilayer screen protective film structure for providing protection to a viewing surface of an electronic device.

2. Description of Related Art

With the advancement in technology, today's electronic devices are usually equipped with a screen or monitor to display the operating status and/or relevant information, thus enabling easier and more intimate device manipulation for the users. Some screen-equipped electronic devices include televisions, display screens/monitors, surveillance cameras, liquid crystal displays (LCDs), cell phones, digital cameras, electronic books, MP3 players, calculators, watches, personal-digital assistants (PDAs), navigation systems, computers, telephones, refrigerators, measuring instruments, entertainment systems, factory machines, etc. Of the abovementioned devices, the LCDs or touch-controlled screens are being most popular among the consumers. The reasons being they are lightweight, portable, and have reasonable price ranges. However, one common issue for the screen is its durability, particularly its resistance to nicks and scratches. Therefore, a screen protective film is usually employed to better protect the screen.

The screen protective films are being used widely among cell phones, cameras, and other portable multimedia devices. Conventional films are often single-layered structures made by plastic material with varying degrees of light permissibility and flexibility. The films usually have an adhesive undersurface bonded to a peel off film. To use the screen protective film, the peel off film is removed as the protective film is applied onto the surface of a screen/monitor.

However, the existing protective films are hermetically sealed or air tight. Improper application of the protective films onto the screens often results in air being trapped between the screen and the film. This scenario is not aesthetically pleasing and may affect the touch-screen operation.

The goal of improving the screen protective films to address the air pocket issue is greatly emphasized by the people skilled in the art.

### SUMMARY OF THE INVENTION

The object of the instant disclosure is to resolve the air pocket issue between the screen and the screen protective film.

Accordingly, the instant disclosure provides a screen protective film structure adaptable on an outer surface of an electronic device having a display portion and a frame portion. The structure has a light-permitting film and an adhesive portion. The light-permitting film is disposed on one side of the display portion, where a central space is formed therebetween. The adhesive portion is connected to the light-permitting film and has a plurality of adhesive protrusions. The adhesive protrusions abut to the frame portion, where a gap is formed between the adhesive protrusions. The gap is in communication with the central space and the ambient. Thus, trapped air between the structure and the screen can be relieved through the gap.

The light-permitting film and the adhesive portion are integrally formed in one-piece.

The light-permitting film is disposed on one side the adhesive portion seamlessly.

A removable protective film is disposed on one side of the light-permitting film and/or the adhesive portion.

The light-permitting film is abutted to a surface of the adhesive portion opposite of the adhesive protrusions.

The adhesive protrusions are triangular, square, column, or irregularly shaped.

The size, shape, and physical features between the adhesive protrusions are identical to each other.

The edge-to-edge region between the display portion and the frame portion corresponds to the inner edge of the adhesive portion.

Based on the above, the described screen protective film structure is capable of protecting the electronic device and eliminates the air pocket issue.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view showing a screen protective film structure of the instant disclosure in use with an electronic device.

FIG. 2A is a perspective view showing a screen protective film structure for a first embodiment of the instant disclosure before disposing on the electronic device.

FIG. 2B is a perspective view showing the screen protective film structure in FIG. 2A disposed on the electronic device.

FIG. 2C is a cross-sectional view of FIG. 2B taken along a cut-line A-A.

FIG. 3 is a cross-sectional view of a screen protective film structure for a second embodiment of the instant disclosure.

FIG. 4 is a cross-sectional view of a screen protective film structure for a third embodiment of the instant disclosure.

FIG. 5 is a cross-sectional view of a screen protective film structure for a fourth embodiment of the instant disclosure.

FIG. 6 is a cross-sectional view of a screen protective film structure for a fifth embodiment of the instant disclosure.

FIG. 7 is a cross-sectional view of a screen protective film structure for a sixth embodiment of the instant disclosure.

### DETAILED DESCRIPTION OF THE EMBODIMENTS

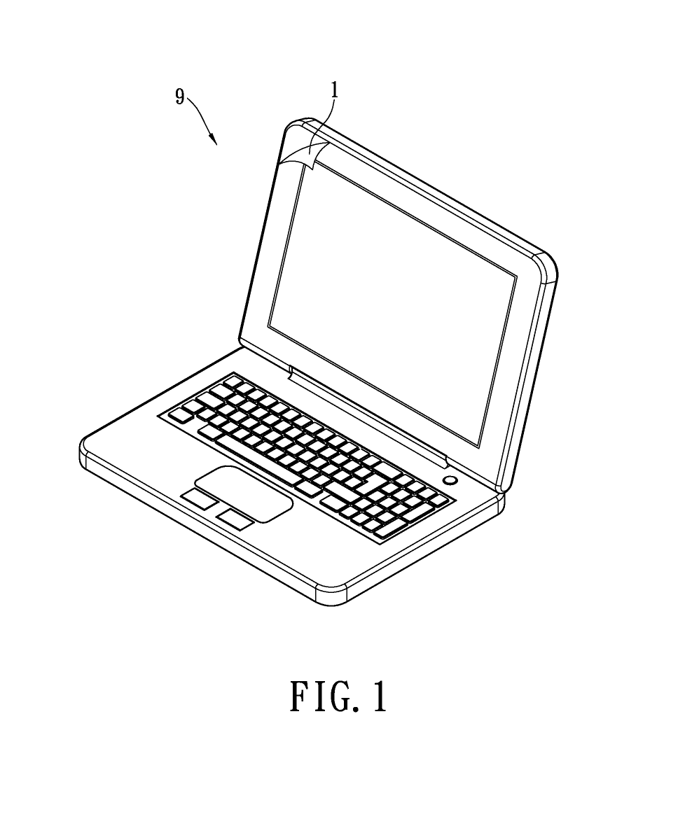

Please refer to FIG. 1, which is a perspective view showing a screen protective film structure 1 of the instant disclosure disposed on an electronic device 9. As shown, the structure 1 is disposed on the screen portion of the electronic device 9. For the exemplary embodiment, the electronic device 9 is a laptop computer. However, the electronic device 9 may also be a TV, a surveillance camera, a LCD, mobile phone, digital camera, e-book, MP3 player, calculator, watch, PDA, navigating system, industrial computer, telephone, refrigerator, calibrating instrument, entertainment system, factory machine, etc.

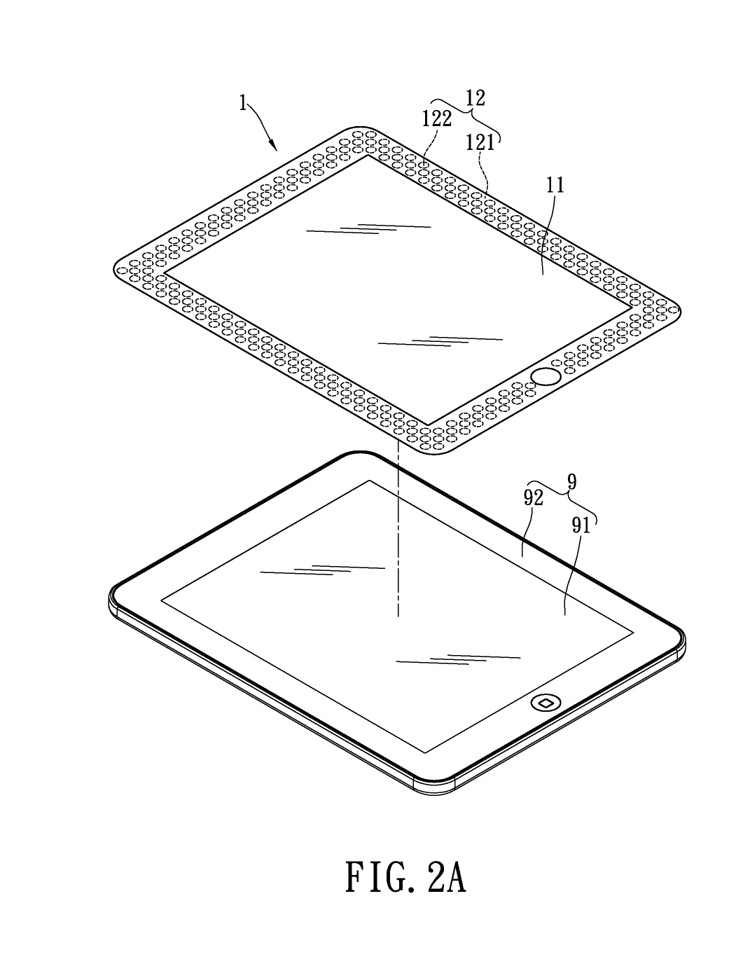

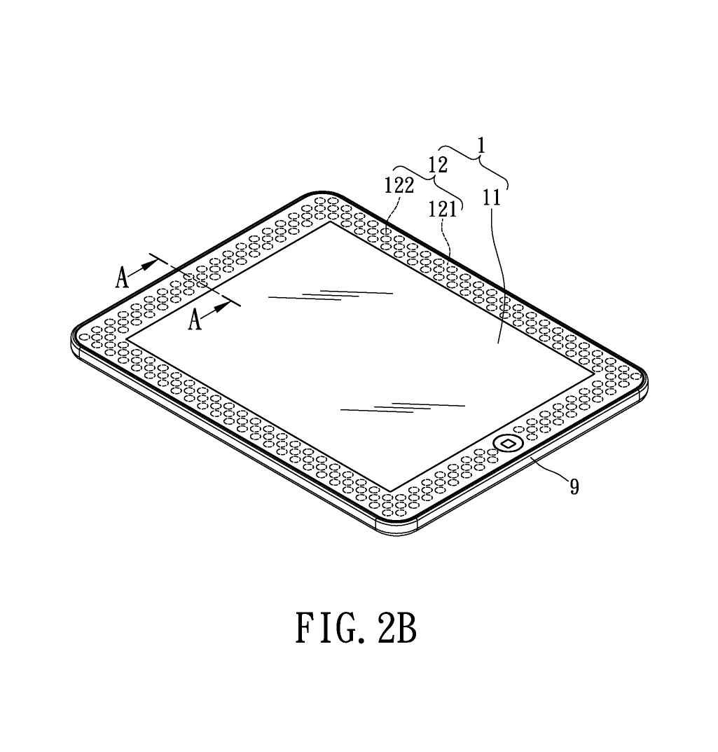

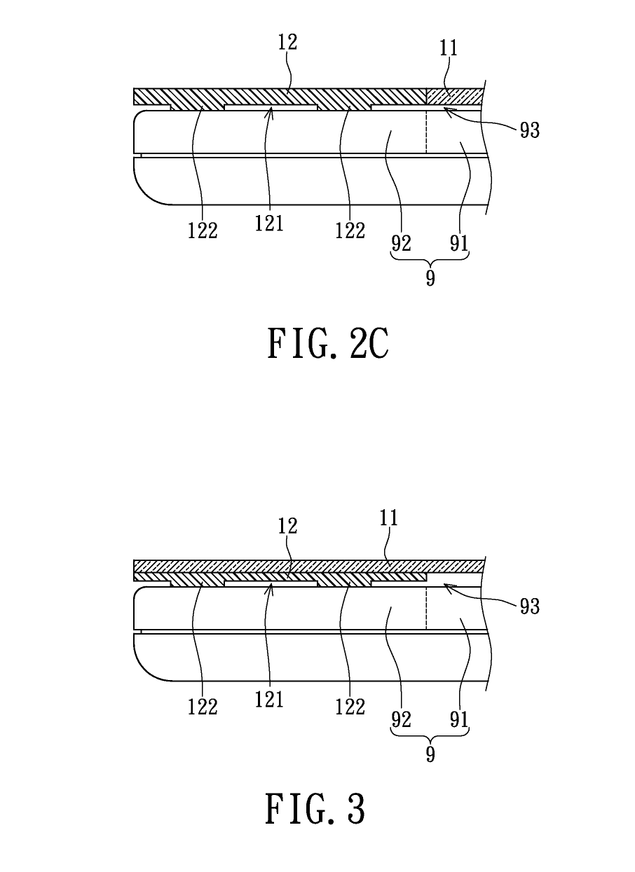

Please refer to FIGS. 2A˜2C. The electronic device 9 has a display portion 91 and a frame portion 92. The frame portion 92 is arranged around the periphery of the display portion 91. The display portion 91 is used to show still images or videos. The structure 1 has a light-permitting film 11 and an adhesive portion 12. The light-permitting film 11 is aligned with the display portion 91. The adhesive portion 12 is connected to the light-permitting film 11 in the same plane, such that the light-permitting film 11 is arranged against the inner edge of the adhesive portion 12. Moreover, as shown in FIG. 2C, a central space 93 is formed between the light-permitting film 11 and the display portion 91. Preferably, the light-permitting film 11 and the adhesive portion 12 are seamlessly connected to one another or being integrally formed in one-piece. Thus, the structure 1 is easier to manufacture and more visually and physically pleasing.

In addition, a plurality of adhesive protrusions 122 is formed on the adhesive portion 12 for adhering to the frame portion 92. As shown in FIGS. 2A and 2B, the adhesive protrusions 122 are column-shaped. The size, shape, and physical features between the adhesive protrusions 122 are the same. In particular, a gap 121 is formed between the adhesive protrusions 122. The gap 121 is in communication with the central space 93 and the ambient. In other words, the gap 121 is formed underneath the adhesive portion 12. When the adhesive portion 12 is adhered onto the frame portion 92, air can still travel inside the gap 121. Thus, trapped air between the light-permitting film 11 of the structure 1 and the display portion 91 of the electronic device 9 (i.e., air in the central space 93) can be relieved from the structure 1 through the gap 121. The air pocket issue can be resolved through the abovementioned structure 1.

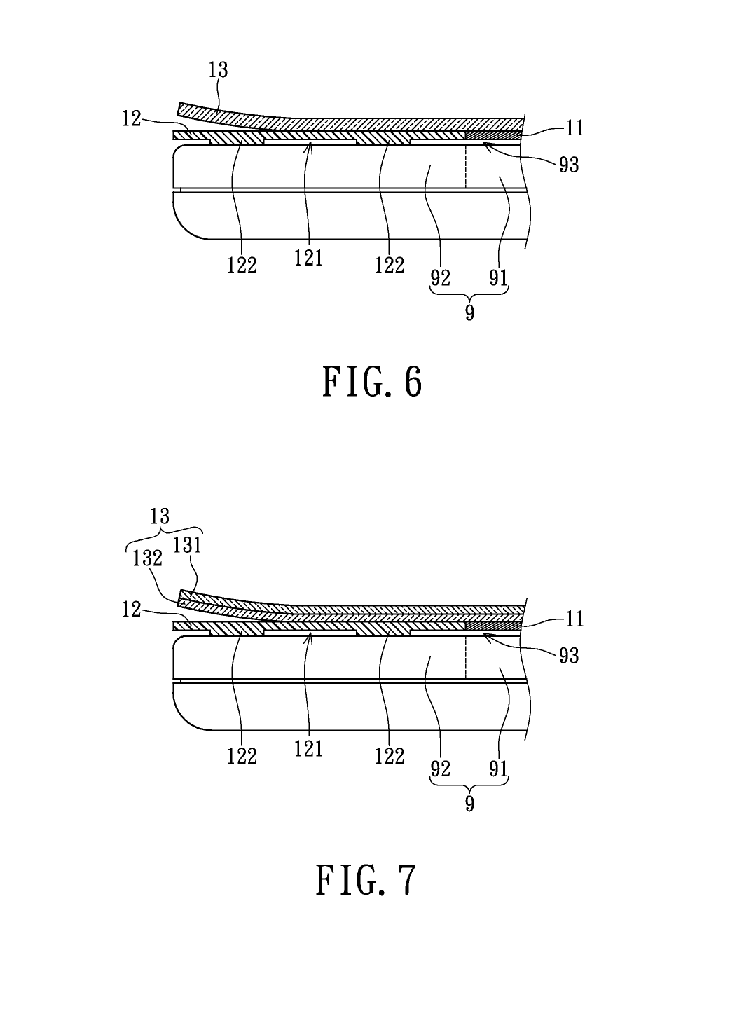

In addition, the edge-to-edge region between the display portion 91 and the frame portion 92 corresponds to the inner edge of the adhesive portion 12. Thus, the adhesive portion 12 does not block the display portion 91 for showing the images and videos. In addition, when using the structure 1, the user can easily align the adhesive portion 12 with the frame portion 92 of the electronic device 9. Moreover, as shown in FIG. 6, a removable protective film 13 can be further disposed on the light-permitting film 11 and adhesive portion 12. Depends on the application and the actual requirement, the protective film 13 may stay or be peeled off from the light-permitting film 11 and the adhesive portion 12.

Please refer to FIG. 3, which shows a screen protective film structure 1 for a second embodiment of the instant disclosure. The light-permitting film 11 is abutted to one side of the adhesive portion 12 opposite of the adhesive protrusions 122. In other words, for the orientation shown in FIG. 3, the light-permitting film 11 is arranged on top of the adhesive portion 12, and the adhesive protrusions 122 are formed under the adhesive portion 12. With such arrangement, the central space 93 is larger in comparing to the previous embodiment.

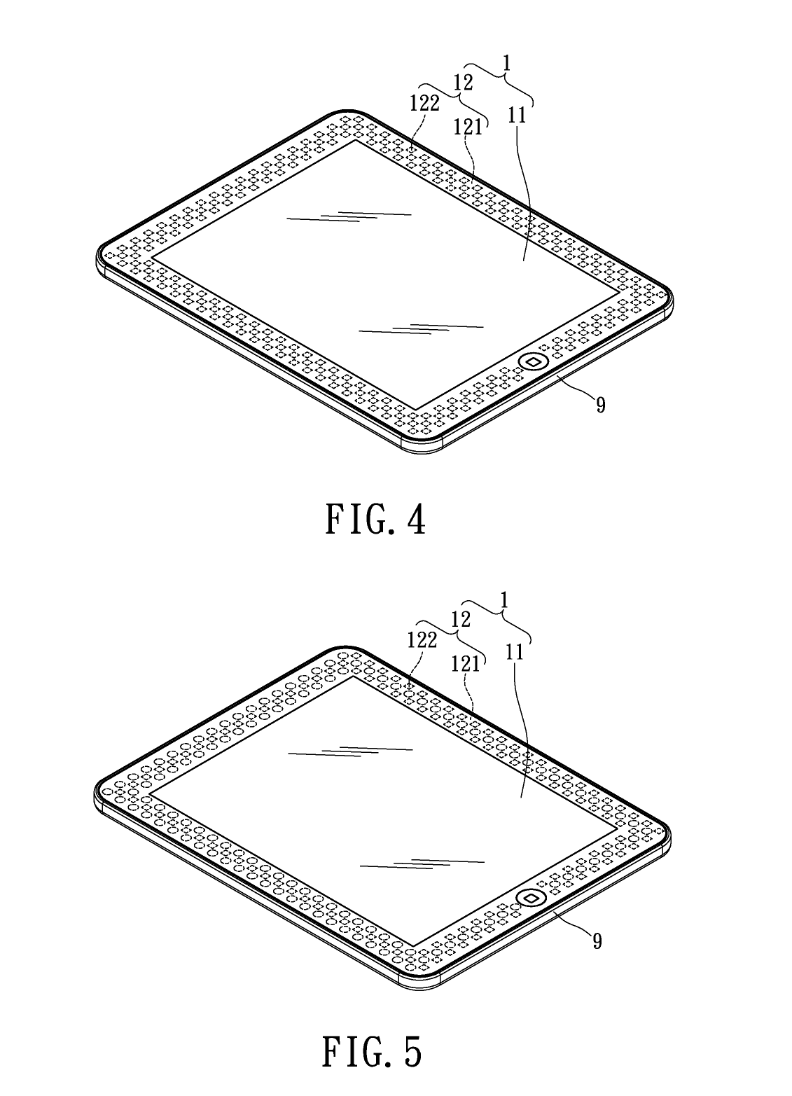

Next, please refer to FIG. 4, which shows a screen protective film structure 1 for a third embodiment of the instant disclosure. In FIG. 4, the film structure 1 is already disposed on the electronic device 9. For this embodiment, the adhesive protrusions 122 are all square block-shaped and orderly arranged. However, alternatively, theses adhesive protrusions 122 may be irregularly arranged as well.

Please refer to FIG. 5, which shows a screen protective film structure 1 for a fourth embodiment of the instant disclosure. For this embodiment, some adhesive protrusions 122 are column-shaped, while others are square-block shaped. Alternatively, the adhesive protrusions 122 may be triangle-block shaped or take on other shapes. Moreover, the adhesive protrusions 122 having two, three, or more different shapes may be disposed together on the adhesive portion 12.

For still another embodiment, the protective film 13 may be a multi-layer structure, as shown in FIG. 7. In particular, the protective film 13 includes a hardened sub-layer 131 and an adhesive sub-layer 132. The adhesive sub-layer 132 is used to fix the hardened sub-layer 131 onto the adhesive portion 12. The hardened sub-layer 131 is preferably made of a plastic material subjected to surface hardening treatment. Thus, the hardened sub-layer 131 has increased hardness and better scratch-resistance. If subjected to surface treatment such as sand blasting, the hardened sub-layer 131 can disperse light to avoid glare. Moreover, the hardened sub-layer 131 may be a special film having anti-glare and/or anti-fingerprint capability. The protective film 13 may even have three or more sub-layers having multi-functional characteristics.

Based on the above, the screen protective film structure 1 is capable of protecting the electronic device 9 and resolving the air pocket issue.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A screen protective film structure adaptable on an electronic device having a display portion and a frame portion, comprising:
an adhesive portion having a plurality of adhesive protrusions configured to aligningly attach to the frame portion of the electronic device; and
a light-permitting film portion in connection with the adhesive portion substantially covering the display portion of the electronic device;
wherein the adhesive protrusions suspendingly support the screen protective film structure over a viewing surface of the electronic device so that a central space is formed between the light-permitting film and the display portion,
thereby enabling the removal of trapped air between the screen protective film structure and the electronic device.

2. The screen protective film structure of claim 1, wherein the light-permitting film and the adhesive portion are integrally formed as a one-piece structure.

3. The screen protective film structure of claim 1, wherein the light-permitting film in connected to the inner edge of the adhesive portion.

4. The screen protective film structure of claim 3, wherein the light-permitting film and the adhesive portion are seamlessly connected to one another.

5. The screen protective film structure of claim 1, wherein a protective film is disposed on the light-permitting film and the adhesive portion.

6. The screen protective film structure of claim 1, wherein the light-permitting film is disposed on one side of the adhesive portion opposite of the adhesive protrusions.

7. The screen protective film structure of claim 1, wherein the adhesive protrusions are triangle-block shaped, square-block shaped, column shaped, or irregularly block shaped.

8. The screen protective film structure of claim 1, wherein the size, shape, and physical features of all the adhesive protrusions are the same.

9. The screen protective film structure of claim 1, wherein the edge-to-edge region between the display portion and the frame portion is aligned to the inner edge of the adhesive portion.

10. The screen protective film structure of claim 1, wherein a removable protective film is disposed on the light-permitting film.

11. The screen protective film structure of claim 5, wherein the protective film is a multi-layer structure.

12. The screen protective film structure of claim 1, wherein the electronic device is selected from a group consisting of laptop computer, digital camera, television, electronic book, mobile phone, calculator, watch, telephone, refrigerator, multimedia player, personal digital assistant (PDA), and navigation system.
